(19) United States
(12) Patent Application Publication
(10) Pub. No.: US 2015/0149387 A1
(43) Pub. Date: May 28, 2015

(54) SYSTEMS AND METHODS FOR CONSTRUCTION OF EXCHANGE TRADED PRODUCTS

(71) Applicant: Millington Securities, Inc., Red Bank, NJ (US)

(72) Inventors: Donald R. Schreiber, JR., Rumson, NJ (US); Matthew E. Schreiber, Rumson, NJ (US); Gary E. Stroik, Millstone, NJ (US)

(21) Appl. No.: 14/552,973

(22) Filed: Nov. 25, 2014

Related U.S. Application Data
(60) Provisional application No. 61/908,785, filed on Nov. 26, 2013.

(51) Int. Cl. G06Q 40/06

(52) U.S. Cl. CPC G06Q 40/06
USPC 705/36 R

(57) ABSTRACT

A method of creating one or more exchange traded products is provided. The method includes the steps of: (a) analyzing a plurality of investor managed individual security accounts to determine at least one investment characteristic for each of a plurality of investors; generating an investment objective and risk profile for each investor based on the results of step (a); and (c) creating one or more exchange traded products using the profiles generated for the plurality of investors.

### CROSS-REFERENCE TO RELATED APPLICATION

This application claims the benefit of U.S. Provisional Application No. 61/908,785, filed Nov. 26, 2013, the content of which is incorporated herein by reference.

### FIELD OF THE INVENTION

The present invention relates to investment management, and more particularly, to improved systems and methods for constructing exchange traded funds.

### BACKGROUND OF THE INVENTION

Two of the most popular retail investment models within the broker and high net worth communities are Separately Managed Accounts (“SMAs”) and Unified Managed Accounts (“UMAs”).

Separately Managed Accounts (“SMAs”) are investment strategy portfolios that are selected by the client, based upon their risk tolerance, where a broker controls the retail investors and High Net Worth (“HNW”) channels. An SMA Registered Investment Advisor (“RIA”) defines the risk models being used, but ultimately the client selects one of the predefined investment models. Under the SMA model the client's broker does receive AUM (“assets under management”) based fees from the SMA advisor under a separate contract, which is why SMAs are often referred to as a two contract investment model.

SMAs are structured so that investors receive no trade transaction charges in return for an annual fixed fee on assets within the investor account. Another key point is that brokers offering SMAs to their clients typically limit the SMA holdings to 30 securities. This cap on security holdings is an effort to control the transaction costs of the broker over time. However, this 30 security limitation also limits the diversification of assets for the investor and could limit the potential returns because of the asset concentration.

The SMA providers RIA retains trade execution rights over the account on behalf of the investor. The RIA of the SMA has strict control over the trade executions and hence control of the market impact costs of trading and commissions. This is very important to the SMA provider as these costs directly affect the returns to the investor.

Unified Managed Accounts (“UMAs”) are asset allocation models sold by brokers to retail and HNW clients whereby the broker offers the investment strategies held by their clients and is responsible for matching the client's risk profile to the investment model consisting of a group of funds. The UMA model pays the broker AUM fees like the SMA model. However, the broker maintains control of the trade executions and these brokers sell the investor's trade orders to party consolidation brokers in return for exchange rebate fees. These exchange rebate fees are not passed onto the investor, but are instead used by the broker to increase their compensation for the UMA model.

Without control of the trade executions by the RIA operating the investment model, the clients suffers as brokers tend to “sell” their trade executions to large electronic platforms that focus more on the speed of execution instead of the share price of the execution and the market impact cost. This results in return declines to the investors as high frequency trading houses will see this order flow quickly, move the price of the execution, effect the daily Volume Weighted Average Price, “VWAP”, all of which results in reduced returns to the beneficial investors of multiple percentage points over the course of the year. UMA returns, when compared to the SMA returns by the same investment model by the same asset manager, tend to fall below the returns of the comparable SMA model.

While both SMA and UMA models have advantages and disadvantages with respect to one another, it would be desirable to provide improved systems and methods for overcoming one or more deficiencies of the existing SMA/UMA models.

### SUMMARY OF THE INVENTION

According to an exemplary embodiment of the present invention, a method of creating one or more exchange traded products is provided. The method includes the steps of: (a) analyzing a plurality of investor managed individual security accounts to determine at least one investment characteristic for each of a plurality of investors; (b) generating an investment objective and risk profile for each investor based on the results of step (a); and (c) creating one or more exchange traded products using the profiles generated for the plurality of investors.

The present invention may also take the form of a computer readable carrier (e.g., a non-transitory computer readable carrier or medium) including computer program instructions which cause a computer to implement the aforementioned method of creating one or more exchange traded products.

According to another exemplary embodiment of the present invention, a system for creating one or more exchange traded products is provided. The system includes (1) at least one computer including computer program instructions for creating the one or more exchange traded products; (2) at least one assembled data structure, assembled by the at least one computer, for use in creating the one or more exchange traded products; and (3) at least one third party data structure used in connection with the at least one assembled data structure and the computer program instructions for creating the one or more exchange traded products.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1A is a flow diagram illustrating a method of creating one or more exchange traded products in accordance with an exemplary embodiment of the present invention;

FIG. 1B is a flow diagram illustrating a method of deconstructing one or more exchange traded products in accordance with an exemplary embodiment of the present invention;

FIG. 2 is a block diagram illustrating a system for constructing an ETP(s) in accordance with an exemplary embodiment of the present invention;

FIG. 3A is an illustration representing an initial process to analyze a plurality of investor holdings in accordance with an exemplary embodiment of the present invention;

FIG. 3B is an illustration representing an initial process to analyze a plurality of institutional investment holdings in accordance with an exemplary embodiment of the present invention;

FIG. 4 illustrates an analysis including a determination as to whether ETPs in a portfolio may be listed as publicly listed securities in accordance with an exemplary embodiment of the present invention;

FIG. 5 is an illustration representing building a theoretical ETP in accordance with an exemplary embodiment of the present invention;

FIG. 6 is an illustration representing certain ETP portfolio analysis and adjustments in accordance with an exemplary embodiment of the present invention;

FIG. 7 is an illustration representing an ETP selection process in accordance with an exemplary embodiment of the present invention;

FIG. 8A is an illustration representing a backwards check of a proposed ETP against an existing investment strategy in accordance with an exemplary embodiment of the present invention;

FIG. 8B is an illustration representing a backwards check of a proposed ETP against an existing institutional investment strategy in accordance with an exemplary embodiment of the present invention;

FIG. 9 is an illustration representing a liquidity analysis of ETPs in a portfolio in accordance with an exemplary embodiment of the present invention;

FIG. 10 is an illustration representing a compliance check of ETPs in a portfolio in accordance with an exemplary embodiment of the present invention;

FIG. 11 is an illustration representing the process of allocating ETPs into a matrix of risk profiles in accordance with an exemplary embodiment of the present invention;

FIG. 12 is an illustration representing a transition of SMA/UMA holdings into one or more ETPs in accordance with an exemplary embodiment of the present invention; and

FIG. 13 is an illustration representing a performance analysis between the ETP returns and the returns of an original investment model in accordance with an exemplary embodiment of the present invention.

### DETAILED DESCRIPTION OF THE INVENTION

In accordance with certain exemplary embodiments of the present invention, inventive systems and methods (e.g., computer implemented methods and controls) have been developed for minimizing the potential performance drop between an SMA investment model and the same models on a UMA platform.

The present invention, as described herein largely focuses on the construction of Exchange Traded Products (“ETPs”), and the transition of the underlying holdings of SMA/UMA accounts to come from an ETP portfolio including the ETPs. By analyzing a plurality of investment accounts (e.g., SMA accounts, UMA accounts, etc.) and deriving common risk and common investment strategies, a plurality of ETPs can be constructed, and one or more ETP portfolios may be generated, where each ETP may be provided as a single security used by broker dealers. Then, the assets in an investment account (e.g., an SMA account, a UMA account, etc.) may be transitioned to shares of a plurality of ETPs from the ETP portfolio matching their desired investment characteristics (e.g., risk tolerance, desired sectors, etc.).

Although the present invention has largely been described in connection with the construction of ETPs, and groupings of ETPs having substantially similar investment aspects as compared to an investor's existing investment account (e.g., a SMA account), it is not limited thereto. After an ETP (and/or an ETP grouping) is constructed, the underlying holdings of the ETP (and/or an ETP grouping from an ETP portfolio) may be further identified, examined and/or deconstructed. By identifying the underlying holdings of the ETP, an investor may acquire a group of stocks/securities that contain the underlying holdings of the ETP (and/or an ETP grouping from an ETP portfolio). However, if the investor's investment account is an SMA, it may be limited to 30 securities—and the ETP (and/or ETP grouping) may include more than 30 securities. In such a case, additional analytics/software may be run in order to provide a selection of the underlying securities from the ETP (and/or ETP grouping) having a predetermined (or maximum) number of underlying securities such that the selection of underlying securities may be acquired by the investor in an investment account (e.g., an SMA).

In certain exemplary embodiments of the present invention, systems and methods are provided to convert Over the Counter (“OTC”) investment strategies packaged as SMAs and UMAs into listed ETPs. Example ETPs include, for example, Exchanged Traded Funds (“ETFs”), Exchanged Traded Notes (“ETNs”), Exchanged Traded Commodities (“ETCs”), Exchanged Traded Mutual Funds (“ETMFs”), and closed end funds. The ETPs will be exchange listed securities with the purpose of protecting the investment performance of the investment strategy after the conversion process (e.g., the conversion of an SMA to include ones of the ETPs, the conversion of the UMA to include ones of the ETPs, etc.).

In some aspects, the present invention is aimed at addressing complaints from wire house brokers concerning how the investment performance of SMA strategies declines once an SMA strategy is migrated to a UMA platform. The inventive systems and methods involves multiple layers of technology (e.g., analytics and software) and databases.

In certain exemplary embodiments of the present invention, a process is provided whereby an SMA (or UMA) strategy, being managed by an RIA, is transitioned through an alignment of the investment positions in the SMAs (or UMAs), into a listed exchange security using a database of investment strategies derived from a set of investment selection rules, asset transition rules, registered investment company rules, Security Exchange Commission (“SEC”) rules, investor approvals, and product structures to form a listed security, or set of listed securities, which have a substantially similar performance to the investment returns which can be applied to either a UMA or SMA investment model.

Trading in individual securities, and the settlement of individual securities in one or a plurality (e.g., perhaps thousands) of individually owned SMA accounts, across dozens of custodial platforms on a daily basis is an inherently inefficient process that can lead to poor price execution, and hence impact performance of the strategy, as managers make portfolio allocation changes which cause multiple custodians to compete with each other in the marketplace to execute orders in the same security. The activity of the multiple participants in the market at once can increase or decrease share prices and increase market volatility. According to the certain exemplary embodiments of the present invention, a new automated approach is provided that can recreate the investment model of one or more existing SMAs (and UMAs), and transition the investment strategy into one or more ETPs. On SMA/UMA broker dealer platforms, the present invention may be used to analyze the selected investment portfolios and to design a listed ETP (or a plurality of ETPs) to replicate the strategy with additional liquidity to the investor, and may have an overall fee structure that is reduced. Changes are delivered to the ETP model allocation instead of to the underlying individual security holdings—and the capital gains impact to the individual investors in the SMA/UMA strategy are minimized.

SMAs are investment models at broker dealers that are typically limited to 30 securities and hence the investments can be concentrated. If such portfolios are modeled, large blocks of individual securities may be sold in one day to manage market trading costs and the cost basis for each individual account to be identical for performance measurement purposes. Spreading orders over multiple trading days may increase the cost basis or compound trading costs, ultimately impacting investor performance.

Trading individual securities within an ETP omnibus account (e.g., a single account) reduces ownership, settlement and trading costs. Further, it permits the ETP manager the discretion to seek liquidity at prices over multiple days. Omnibus trading improves trade anonymity by reducing information leakage across multiple custodian platforms, which improves the quality of price execution. As the ETP manager executes security transactions in-kind the ETP can manage performance and capital gains for the benefit of the investors' SMA account.

Tactical allocation changes or active management in traditional SMA products leads to a high tax cost impact especially from short-term gains. The inventive ETP creation and redemption process can significantly improve tax efficiency by reducing the impact of short-term and long-term gains on investor's capital.

By changing the registration of individual securities from individual accounts to an ETP omnibus account, the number of individual securities held through the ETP may be increased, thus providing enhanced diversification, beyond a 30 security limitation, without an increase in settlement, registration and trading costs to the investor.

A typical broker-dealer SMA's minimum average account size may range between $50,000 to $250,000 dollars. In smaller accounts who often purchase securities in less than round lot size (less than 100 shares) the price per share is higher than the round lot and the commission per share is higher. This precludes the investor from using enhanced security and portfolio hedging opportunities through the use of equity options. In connection with certain aspects of the inventive ETP model, options are available to successfully reduce loss and enhance performance in an ETP that is managed in a substantially similar manner to larger SMA accounts. The omnibus account enables the use of enhanced risk management tools for the SMA account now holding the ETP(s).

Thus, certain aspects of the present invention provide one or more of a plurality of potential benefits to investors including: tax efficiency; enhanced diversification; improved execution; reduced execution costs; reduced custodian fees; reduced block trading price impact; increased anonymity and front running protection; enhanced hedging opportunities; securities lending revenue opportunities; and performance enhancements.

Certain exemplary methods in accordance with the present invention include one or more of the following steps: (1) select and finalize an investment strategy which matches a current SMA or UMA strategy at a third party broker dealer, which meets the risk profile and return expectations of investor; (2) use investment strategy rules applied against a universe/grouping of predefined securities (e.g., equities, bonds, money markets, futures, derivatives, etc.), to select ones of the investment securities (e.g., to be included in an ETP(s)) to achieve the investment strategy of the SMA or UMA; (3) perform a liquidity analysis on the selected investment securities to determine an investment capacity of the group of selected securities to be used within the SMA or UMA strategies; (4) apply automated rules to AUM capacity of the investment strategy to determine potential SEC reporting limits on each security within the AUM capacity against all other securities within the select group—and as determined by the SEC rules, a second set of rules may be applied to adjust the AUM capacity securities to remain below the SEC reporting limits or may leave the AUMCAP selections as originally determined by the first set of rules; (5) apply automated RIC rules to AUM capacity to determine potential violations of IRS rules regarding diversification; (6) apply automated rules in support of product selection of listed security selection analysis so as to match the best of class of ETP structure needed to deliver the original SMA or UMA investment returns; and (7) apply automated rules to support transition of SMA or UMA assets into listed ETP or ETPs in order to mitigate the SMA or UMA portfolio strategy expected to generate the highest returns with a lower ownership cost structure in order to deliver better returns to the investor.

The databases utilized, and results of various of the process steps described herein, will be governed by the availability of the data, data density, and frequency of the data updates. Daily information on intraday trading prices and trading volumes and the universe of selected securities is an exemplary method. The desired data may not be available from the marketplace and may need to be enhanced so that the final data can be stored in a computer and the analytics/software/algorithms may be used to predict the final listed product security components and their expected outcomes.

The solution according to certain exemplary aspects of the invention is to provide multiple listed security wrappers around investment strategies, which are held on a client by client basis, in order to preserve the performance of the investment strategy as it migrates from an individual broker account to UMA account platforms serving multiple clients, treated as one group of investors.

The process of the investment strategy can vary on the underlying investor account, but the selection of the regulatory wrapper to meet the specific strategy is a matrix of selections leading to the optimal listed product design and the on-going benefits derived from their omnibus structure.

The matching of the investment strategy migration to the UMA platform using listed products, which represents investment objectives and incorporates specific client risk objectives of a large group of investors, while passing through the security selection matrix will minimize the tax and regulatory structures that must be incorporated in the final security selection process. High risk investors, with short holding periods may generate a security selection decision which will be different from a low risk investor with a long-term investment horizon.

The selection of each security wrapper will have an inherent additional layer of ownership costs and the security selection process will generate a table of cost savings in the investment strategy for each individual investor sufficient to match or exceed the cost of the new exchanged listed security wrapper which will be added to the UMA platform to deliver the identical investment strategy.

The present invention may be applied to the selection of all security types listed on public exchanges for equity, fixed income and commodity products used in either SMA investment products being moved, replicated or transferred to UMA investment platforms.

A key difference between UMA platforms and SMA platforms is the manner in which the portfolios being traded within the investment strategies are executed within the market. SMA portfolio providers prepare the investment models and execute the trades on behalf of the beneficial owner of the securities. SMA providers focus on minimizing trade execution costs which include market entrance costs, market exit costs and commission costs. In active portfolio strategies these costs are significant. The typical portfolio of an SMA provider contains around thirty securities and requires a very high level of supervision during every portfolio rebalance.

UMA platforms are different in that the portfolio provider is not responsible for the execution of the underlying security changes to the UMA client portfolio. UMA investment strategies usually contain less than 15 omnibus securities that are diversified compared to their SMA counterparts. UMA trades are executed by the UMA platform providers. The platform advisor will typically sell their order flow to third party brokers with direct exchange access in return for commission sharing and exchange liquidity rebate fees. As a result the impact to investors is greater and reduces the overall performance of the portfolio to the beneficial owner. Performing a high level of due diligence over the best execution analysis for hundreds/thousands of UMA clients involves a significant level of effort to confirm that the executing broker has minimized the market impact costs for the clients on all of the securities. Also, as the UMA brokers do not execute the trades directly, they have little responsibility for “best execution” thus limiting their liability to the investor.

In accordance with the present invention, an exemplary solution to the problem above is to package an SMA strategy into a listed security that replaces the individual security holdings on an SMA platform such that the owner of the RIA portfolio investment strategy maintains control of the trade—the individual portfolio securities and the UMA platform provider is limited to only a few exchange executions in the SMA ETF that would be needed to deliver the SMA portfolio provider's strategy. A UMA of SMA ETPs would provide the UMA platform provider using the UMA model provider, who might also be the issuer of the SMA ETPs, with a set of SMA ETPs that deliver the overall investment strategy, but significantly limits the performance loss associated with selling the UMA order flow.

The process depends upon the selection of the proper regulatory wrapper for the listed product. To achieve this, multiple computer databases are provided which use the liquidity of the underlying securities of the investment strategy, the RIC rules necessary for the analysis, as determined by the RIA, and the set of target investor types for the product based upon current OTC strategies.

A liquidity database looks at the historical pricing data of the securities selected for the ETP, market impact costs, and asset allocations, over various time periods, to derive the AUM capacity (“AUMCAP”) for each time period. The AUMCAP permits the owner to run the AUMCAP by time period through a set of regulatory product type rules in order to derive the best regulatory product type for each investment strategy product AUMCAP (“PAUMCAP”).

The investor types are roughly described as institutional only, institutional and general publicum, or general public only. Each type of investor group has a preferred PAUMCAP model that reflects the assets the strategy is capable of holding over predetermined investor holding periods as measured in weeks, months, quarters, and extended holding periods. These holding periods will be applied against the asset type including, for example: (1) closed-end funds; (2) passive exchange traded funds (“PETFs”); (3) active disclosed exchanged traded funds (AETFs”); (4) non-disclosed active exchange traded funds (“NETFs”); and (5) exchange traded notes (“ETNs”). The PAUMCAP per time period will create a target client product set based upon the four options above target product AUMCAP (“TPAUMCAP”).

Each TPAUMCAP also desirably takes into consideration the owner's current OTC products (“OTC”) for the projected time periods of the TPAUMCAP. The TPAUMCAP is desirably adjusted for each strategy by removing the OTC calculation to produce the issued final IAUMCAP (“FTPAUMCAP”).

The FTPAUMCAP will be processed through the regulatory structure matrix to produce the product regulatory set (“PRS”). The PRS and FTIAUMCAP will use the product regulatory cost matrix, the final optimal product regulatory structure, and FTPAUMCAP over the optimal time period for the recovery of the owner's upfront investment costs to deliver the listed investment strategy to the target client (“IFTPAUMCAP”).

Aspects of the present invention involve the use of specific program applications that control a single investment strategy across multiple brokers to the individual investor and then consolidates them into a set of investment strategies and trade executions that transition the multiple SMA investments into a single security wrapper which can be publicly traded to deliver the performance under a UMA program with substantially similar returns and a reduction in future capital gains to investors after a one-off event which liquidates the original SMA holdings.

Once the transition process is complete, and the operation is confirmed as complete, the asset balances, represented by the SMA ETPs of each investor's account across multiple brokers is confirmed and equivalent to the value prior to the transition, less an anticipated one time expense.

This process takes into consideration the sales price of the original holdings, the purchase price of the new security and all of its related securities, commissions and final market closing price of the newly constructed security.

The listed IFTPAUMCAP has many applications when applied to the UMA platform offerings. SMA strategies have risk analysis for investor types that are derived by the SMA investment model provider. While UMA risk models tend to be broader in that they focus on asset allocation models as part of the investor risk assessment. The use of IFTPAUMCAP listed securities permit the UMA model provider to add the IFTPAUMCAP as a client core holding or as a tactical asset allocation to the asset allocation model to derive enhanced returns and diversification to the client's investment portfolio.

With the marketplace growth in listed product asset types it has become feasible for UMA platforms to increase their asset allocation from traditional cash, equity and debt only models to include currency, commodities, and hard to own foreign markets. Certain of the methods disclosed herein can be used for individual asset classes or combination of asset classes, based upon the investment strategy and available asset data required to populate the databases.

The conversion of the SMA security assets into the listed product structure is accomplished using, for example, a set of defined procedures, to help minimize the costs to investors and reduce the risks of the broker dealer execution costs that is performing the process on behalf of the beneficial owners of the prior SMA assets held at many custodial accounts at other broker dealers.

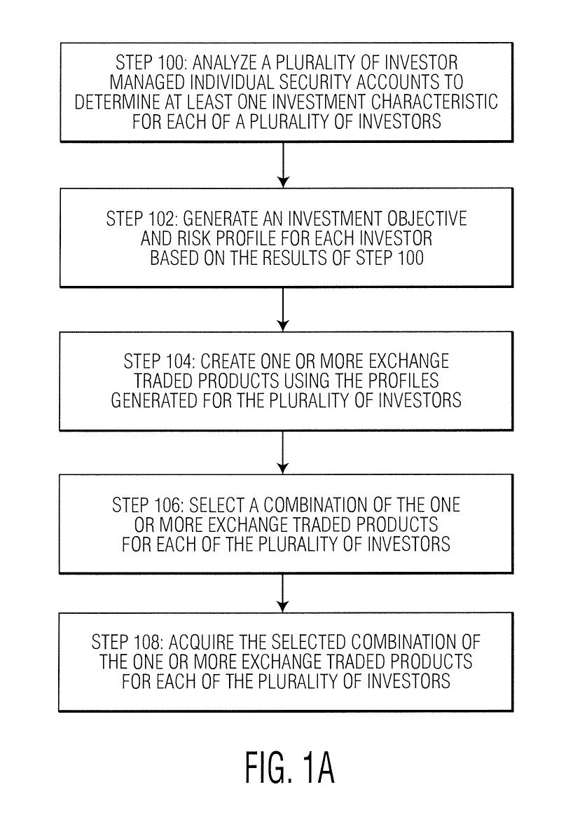

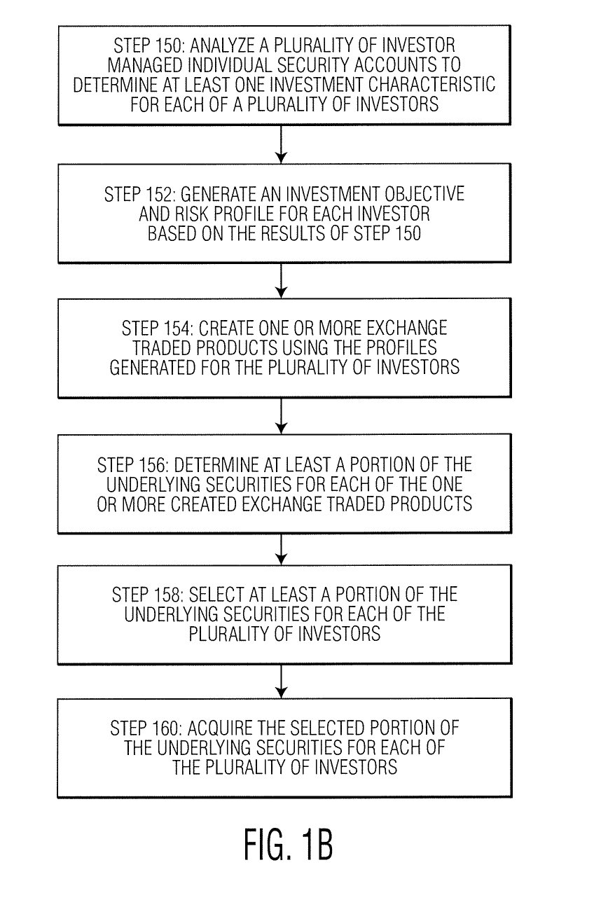

FIG. 1A is a flow diagram illustrating a method of creating one or more exchange traded products (e.g., ETFs, ETCs, ETMFs, and closed end funds) in accordance with an exemplary embodiment of the present invention. At Step 100, a plurality of investor managed individual security accounts (e.g., SMAs, UMAs, etc.) are analyzed to determine at least one investment characteristic (e.g., where exemplary investment characteristics relate to a risk tolerance for each of the plurality of investors, where an exemplary investment characteristic includes a risk spectrum for each of the plurality of investors—where the risk spectrum may include an allocation between various risk tolerance levels by allocation percentage for each of the plurality of investors, etc.) for each of a plurality of investors. At Step 102, an investment objective and risk profile is generated (e.g., as described herein) for each investor based on the results of Step 100. At Step 104, one or more exchange traded products is created using the profiles generated for the plurality of investors. At Step 106, a combination of the one or more exchange traded products created at Step 104 is selected for each of the plurality of investors. For example, a given investor may have 10% of a given ETP (e.g., high risk), 50% of another ETP (e.g., moderate risk), and 40% of yet another ETP (low risk). At Step 108, the selected combination of the one or more exchange traded products are acquired for each of the investors.

FIG. 1B is similar to FIG. 1A, except that in FIG. 1B, after the one or more exchange traded products are created, the one or more exchange traded products are deconstructed in order to determine the underlying securities of the one or more exchange traded products. More specifically, steps 100, 102, and 104 of FIG. 1A are repeated as steps 150, 152, and 154 of FIG. 1B. At FIG. 1B, the one or more exchange traded products are deconstructed/examined in order to identify and/or determine the underlying securities of the one or more exchange traded products. That is, in certain circumstances, an investor may not wish to acquire shares of the one or more ETPs in an investment account (e.g., SMA). Rather, the investor may want to acquire the underlying securities of the ETPs, or a subset of the underlying securities (e.g., because the investor may be limited to a fixed number of securities in their investment account, such as 30 securities in an SMA account—and if the underlying securities of the creates ETPs exceed 30, then the investor may desire to acquire a subset of the underlying securities). It is desirable that the underlying securities (and/or the subset of the underlying securities) have a substantially similar investment objective and risk profile for the selected investor (e.g., as determined by further analytics/software used to deconstruct the now created ETPs). Thus, again referring to FIG. 1B, at step 156, the one or more exchange traded products created at step 154 are deconstructed (e.g., analyzed, using analytics and/or software) in order to determine at least a portion of the underlying securities of the created exchange traded products. By identifying the underlying securities/holdings of the ETPs, an investor may acquire a group of stocks/securities that contain the at least a portion of the underlying securities/holdings of the ETPs. At step 158, at least a portion of the underlying securities are selected for a given investor (or class of investors). For example, in the selection of step 158, additional analytics/software may be run in order to provide a selection of the underlying securities from the ETPs having a predetermined (or maximum) number of underlying securities such that the selection of underlying securities may be acquired by the investor(s) in an investment account (e.g., an SMA), and may have the desired investment objectives (e.g., risk profile, investment strategy, etc.). After identifying the selected the desired underlying securities at step 158, shares of the selected underlying securities are acquired for the investor at step 160 (e.g., in a investment account such as an SMA).

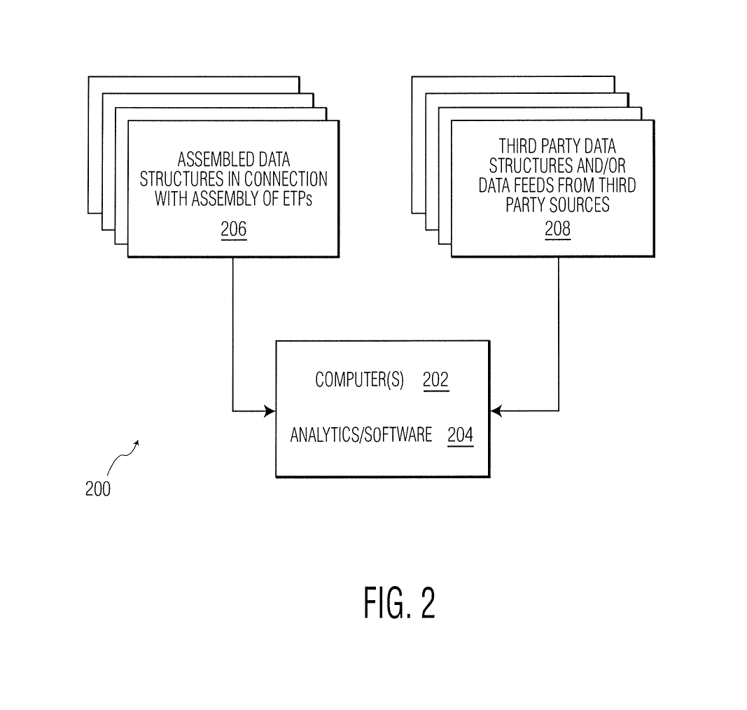

FIG. 2 is a block diagram illustrating a system 200 for constructing (and/or deconstructing) ETPs. System 200 includes computer 202 (e.g., which may be a plurality of computers which may include one or more servers, where such computers may be in communication with one another), assembled data structures 204 (e.g., database structures assembled in connection with the construction and/or deconstruction of a plurality of ETPs), and a plurality of third party data structures 206. As will be appreciated by those skilled in the art, the communication paths between computer 202 and assembled data structures 204, and between computer 202 and third party data structures 206, may take any of a number of forms such as wired communication paths, wireless communication paths, etc.

Computer 202 includes analytics/software 204. As described throughout the present invention, analytics and/or software are used throughout the present invention in connection with various aspects of the present invention. Analytics/software 204, illustrated in FIG. 2, may provide this functionality.

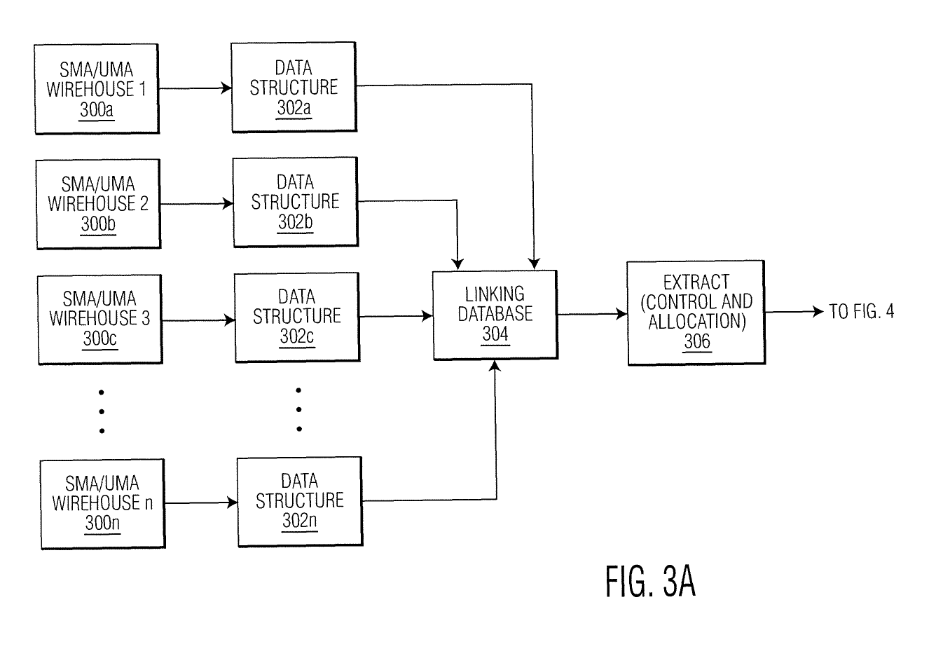

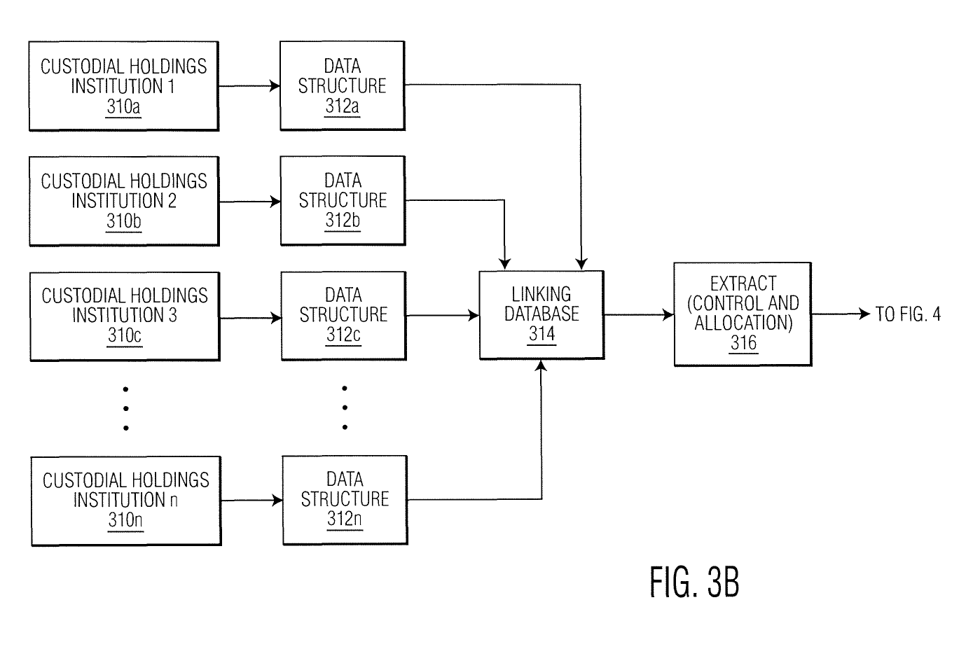

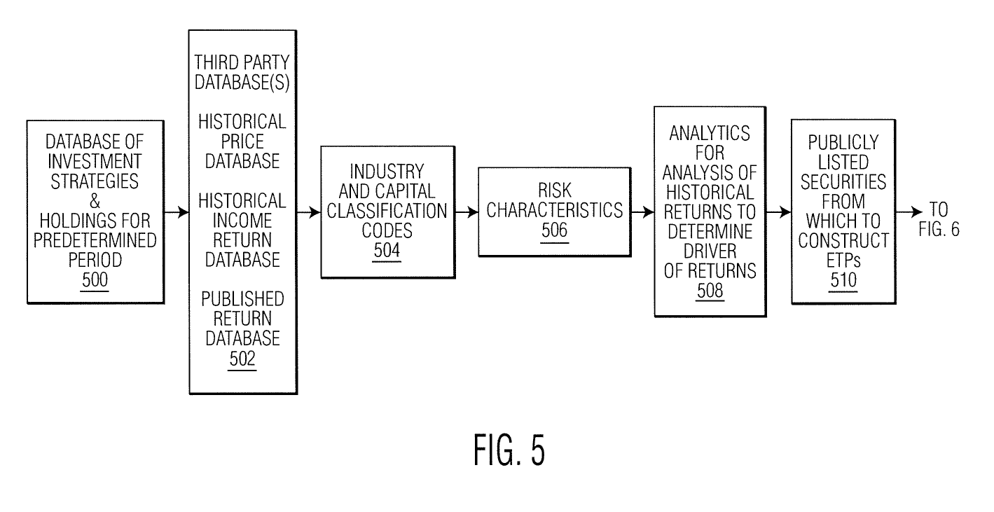

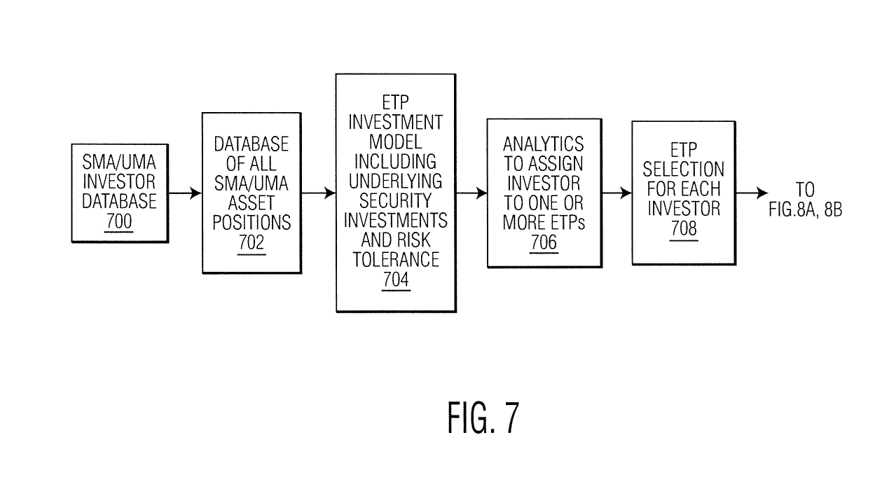

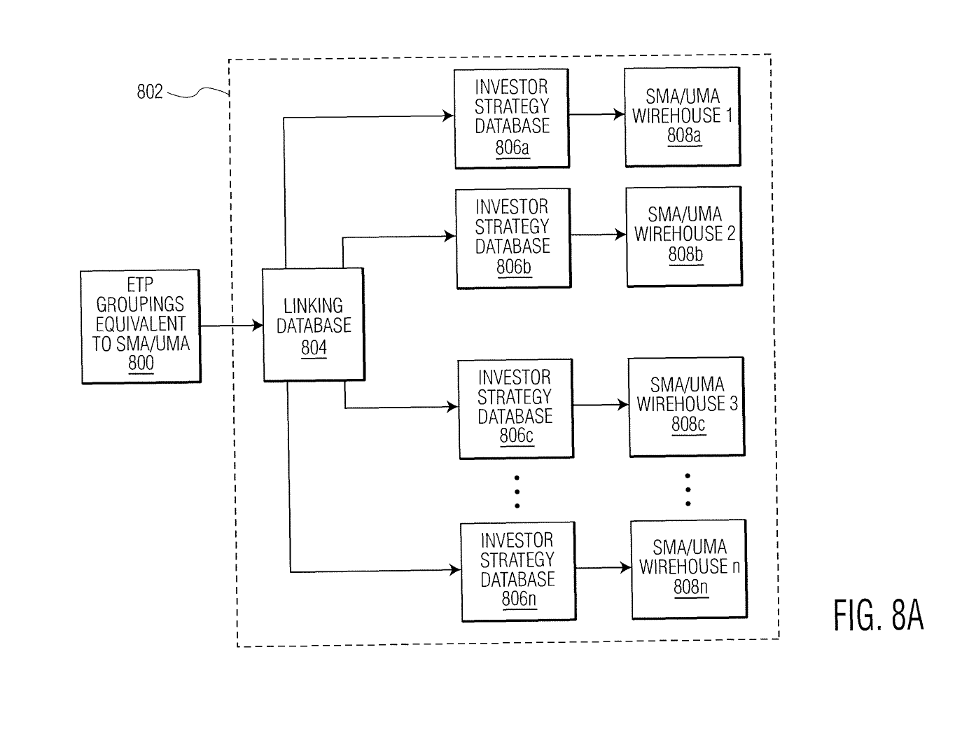

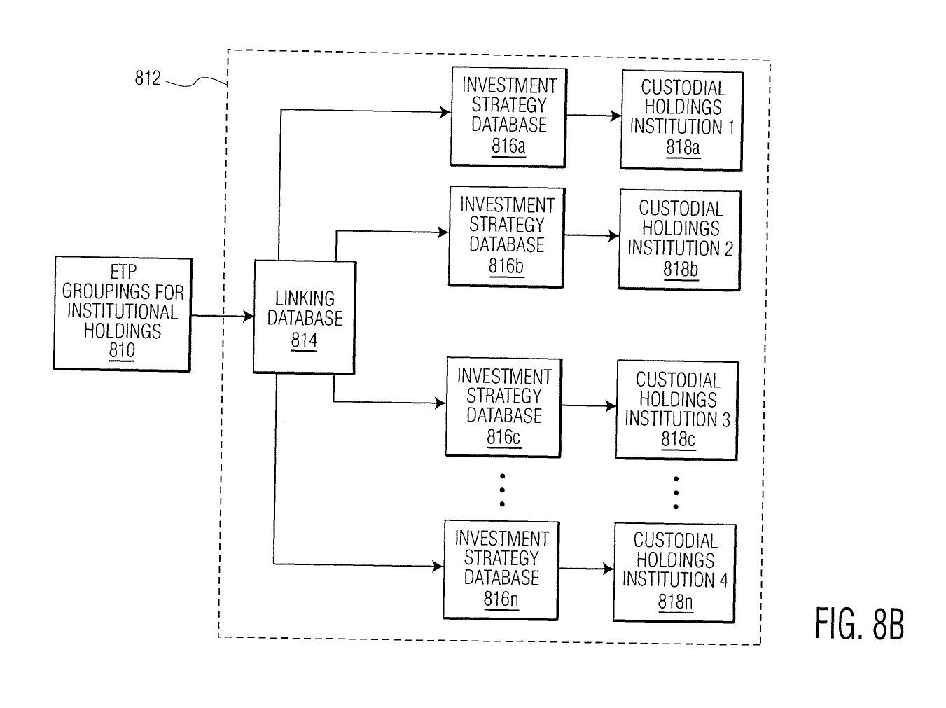

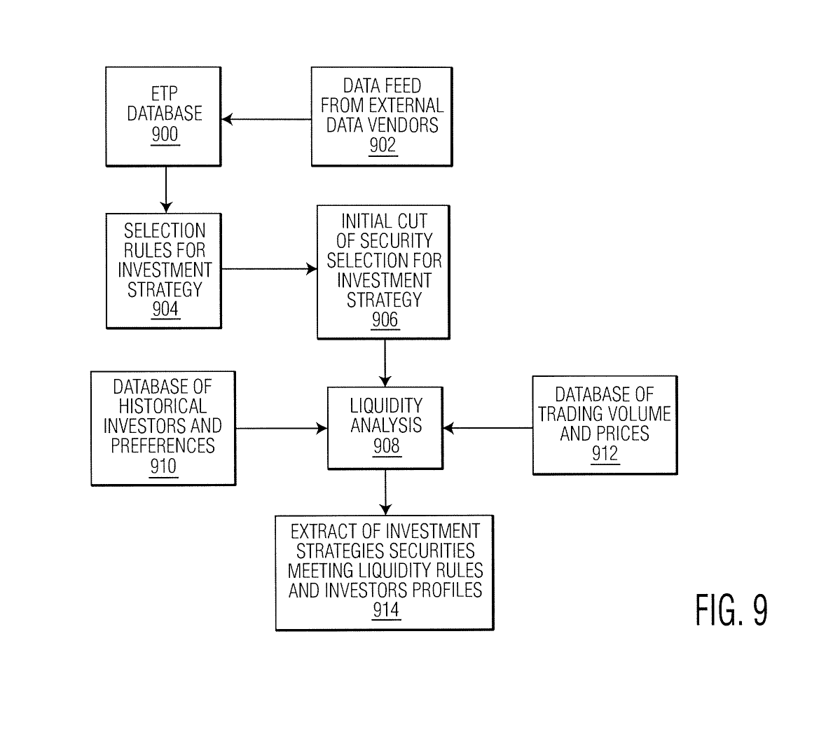

Exemplary data structures included in assembled data structures 204 include: data structures created related to each investor account (e.g., data structure 302a in FIG. 3A, investor database 806a in FIG. 8A, etc.); linking databases (e.g., linking database 304 in FIG. 3A); databases of investment strategies derived by analytics/software 204 from predefined rules (e.g., investment selection rules, asset transition rules, registered investment company rules, SEC rules, investor approvals); liquidity databases (e.g., which may be used in connection with the analysis of FIG. 9); extract databases (e.g., such as extract database described in connection with FIG. 5); SMA/UMA investor databases and SMA/UMA asset position databases (e.g., such as databases 700, 702 in FIG. 7); ETP databases (e.g., such as database 900 of FIG. 9); historical investor databases (e.g., database 910 in FIG. 9); amongst others.

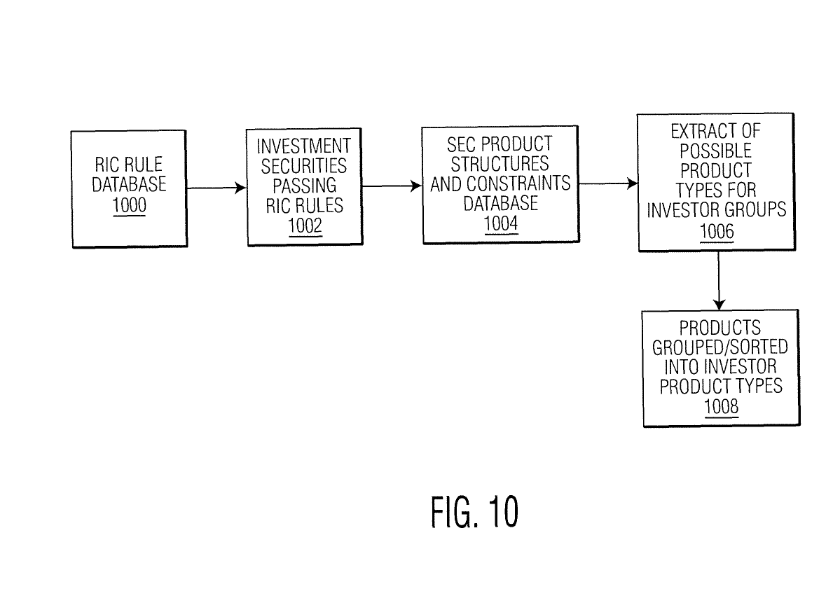

Exemplary data structures included in third party data structures 206 include: data structures including historical price data, historical income return data, and published return data for the underlying securities included in the extract data (e.g., database 502 described in connection with FIG. 5); data structures related to industry and capital classifications; data feeds used in connection with ETP construction/deconstruction (e.g., data feed 902 in FIG. 9); trading volume and price data structures (e.g., database 912 in FIG. 9); RIC/SEC rules data structures (e.g., databases 1000 and 1004 in FIG. 10); amongst others.

Of course, the outline of the data structures above in connection with FIG. 2 is exemplary in nature. That is, certain of the data structures 206 indicated as “assembled” above may be provided by third parties, and data structures 208 indicated as coming from third parties may be “assembled”. Further still, a third party data structure may be enhanced or modified to becomes “assembled”, and vice versa.

In any event, and as described herein, analytics/software 204 uses the information provided by the assembled data structures 206, and the third party data structures and data feeds 208, to perform the various functions described herein, including but not limited to the construction and deconstruction of the ETPs.

FIGS. 3A-3B, 4-7, 8A-8B and 9-13 illustrate various exemplary details which may be used in the construction or deconstruction of one or more exchange traded products in accordance with the present invention (e.g., where certain of those such details may be utilized in connection with the exchange traded product creation process of FIG. 1 and/or the system of FIG. 2).

FIG. 3A illustrates an initial process to analyze a plurality of investor holdings (e.g., SMAs, UMAs, etc.) at the account level over a period of time. This initial process may be performed, for example, to discover the investment strategy and risk profile of each of the investors. As shown in FIG. 3A, a plurality of investor accounts 300a, 300b, 300c, . . . , 300n are shown, each associated with a given wirehouse (e.g., Wirehouse 1, Wirehouse 2, Wirehouse 3, . . . . Wirehouse n). Each of the investment accounts may be, for example, an SMA or a UMA. A data structure (e.g., data structures 302a, 302b, 302c, . . . , 302n) is created in connection with each investment account. For example, a data structure 302a (e.g., a database or other data structure) is created in connection with investment account 300a. Each individual data structure 302a, 302b, 302c, . . . , 302n includes information about the client/investor who owns the respective investment account such as, for example, what specific holdings/investments the client holds, how many shares of which investment the client holds, how long the client has held the given investments, data about the client's investment strategy and risk tolerance, data related to the retirement date (or age) of the investor, etc. The information from each individual data structure 302a, 302b, 302c, . . . , 302n is aggregated in a linking database 304. Linking database 304 stores the investor and wirehouse relationships, and the account strategy (e.g., the SMA strategy). Using linking database 304, the collective investment data from investor accounts 300a, 300b, 300c, . . . , 300n is able to be reviewed, analyzed, etc.—but with the individual account detail intact (and linked back to the individual account inside the broker/dealer, for example, data in linking database 304 is “tagged” to connect it to a specific investor) as desired.

Using linking database 304, analytics may be performed at a macro level looking at all investments (instead of at a micro level, looking at the investments, investor by investor). For example, linking database 304 may receive investment data related to thousands of different investment accounts 300a, 300b, 300c, . . . , 300n (via corresponding data structures 302a, 302b, 302c, . . . , 302n). Using analytics and related software, these thousands of investment accounts may be summarized by a relatively small number of different investment strategies and/or different risk models. For purposes of illustration, data from 20,000 different investment accounts may collected in linking database 304, with the output at extract 306 being 10 different investment strategies and 6 different risk models. Extract 306 uses control and allocation analytics/formulas to make certain that all accounts included in linking database 304 are included in the extract output, for example, where the investment position of each investor is represented in the extract output (i.e., where the output of extract 306 may be details related to the 10 different investment strategies and 6 different risk models).

FIG. 3B is an illustration similar to that shown in FIG. 3A, except that in FIG. 3B the investment accounts are custodial institutional investment accounts (e.g., group pension funds, group retirement accounts, etc). Such custodial holdings are typically held by custody banks (custodial holdings institutions), for example, on behalf of pension funds. Typically, these accounts would be much larger than the accounts of FIG. 3A (e.g., they could have many more than 30 securities, for example, such accounts may have thousands of securities). Further, while the analysis done in connection with the investment accounts in FIG. 3A is risk oriented (e.g., high risk, medium risk, low risk, etc.), the analysis done in connection with the institutional investment accounts in FIG. 3B may be more liability (or obligation) driven. Issues with such liability driven investments include, for example, how many people will retire in a given year, how many people will die in a given year, how much money does the account need to pay out next year, etc. Otherwise, the analysis of FIG. 3B is similar to that of FIG. 3A.

Referring specifically to FIG. 3B, a plurality of institutional investment accounts 310a, 310b, 310c, . . . , 310n are shown, each associated with a given custodial holdings institution (e.g., Institution 1, Institution 2, Institution 3, . . . . Institution n). A data structure (e.g., data structures 312a, 312b, 312c, . . . , 312n) is created in connection with each institutional investment account. For example, a data structure 312a (e.g., a database or other data structure) is created in connection with institutional investment account 310a. Each individual data structure 312a, 312b, 312c, . . . , 312n includes information about the institutional investor/client (e.g., pension or retirement fund) who owns the respective institutional investment account such as, for example, the obligations of the account by time period (e.g., related to members of the pension/retirement account who may retire, die, etc.), what specific holdings/investments the client holds, how many shares of which investment the client holds, how long the client has held the given investments, data about the client's investment strategy and risk tolerance, etc. The information from each individual data structure 312a, 312b, 312c, . . . , 312n is aggregated in a linking database 314. Linking database 314 includes data related to the strategies and holdings for the institutional clients, based at least in part on current and future liabilties. Using linking database 314, the collective investment data from institutional investor accounts 310a, 310b, 310c, . . . , 310n is able to be reviewed, analyzed, etc.—but with the individual account detail intact as desired.

Using analytics and related software, all of the institutional investment accounts may be summarized at extract 316 with a relatively small number of different investment strategies and different risk models. Extract 316 uses control and allocation analytics/formulas to make certain that all institutional investment accounts included in linking database 314 are included in the extract output, for example, that the investment position of each investor is represented in the extract output.

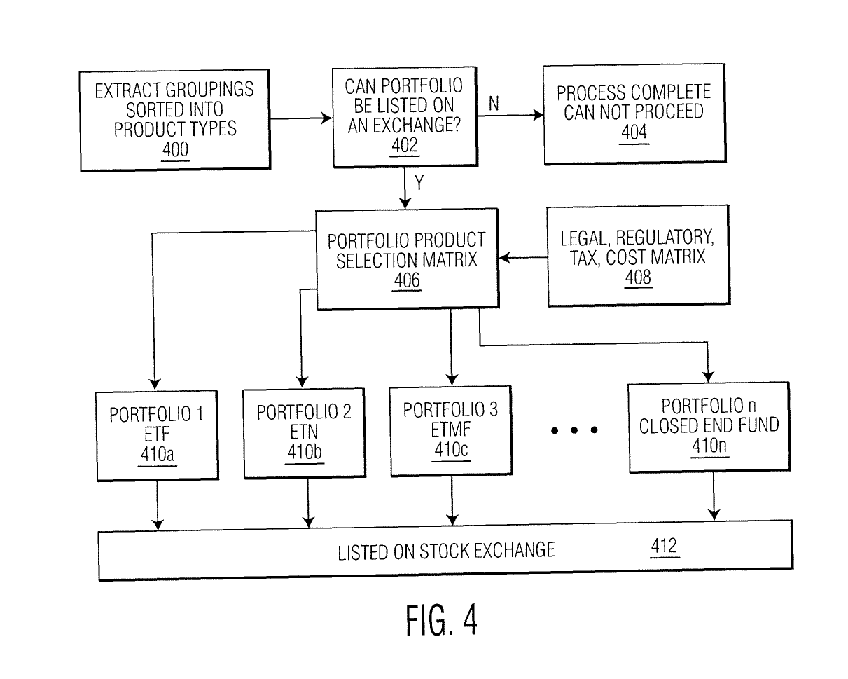

Regardless of the system of investments being analyzed (e.g., individual investment accounts as in FIG. 3A, institutional investments accounts as in FIG. 3B, etc.), the output of the relevant extract 306, 316 is provided to the process shown in FIG. 4. At extract groupings 400, the information from extract 306, 316 is grouped into product types. For example, the summary of different investment strategies are sorted into a list of portfolios using analytics and software (e.g. the 10 strategies in the example above may be sorted into ten different portfolios), where each portfolio is a group of one or more product types. At block 402, a determination is made to see if each portfolio can be listed on an exchange. That is, can the portfolio take the form of a publicly traded security? As is known to those skilled in the art, some product types (e.g., private placement bank loans, whole loans, reverse mortgages, etc.) are typically not publicly listed. Also at block 402, a determination may be made as to whether there is sufficient capital to launch the proposed portfolio(s).

If a determination is made at block 402 that the portfolio can not be listed in a public exchange, then the process proceeds to block 404 (and the process for that proposed portfolio ends). If the portfolio can be listed on a public exchange, then the process proceeds to portfolio product selection matrix 406. Analytics and software at matrix 406 are used to determine what exchange traded product (ETP) each portfolio should be—that is, using analytics and software (and desired strategies and risk profiles) analytics are run to create products to match the different portfolios. Additional information (e.g., legal constraints, regulatory constraints, tax considerations, etc.) from matrix 408 may be utilized in connection with the decision made by portfolio product selection matrix 406. As shown in FIG. 4: an ETF 410a (exchange traded fund) has been selected for portfolio 1; an ETN 410b (exchange traded note) has been selected for portfolio 2; an ETMF 410c (exchange traded mutual fund) has been selected for portfolio 3; and a closed end fund 410n has been selected for portfolio n. Theoretically, each of these exchange traded products may be listed on a stock exchange as shown at block 412.

At FIG. 5, a proposed set of investment models (e.g., including combinations of publicly traded securities) are built, that is, models are built to align past investment data (e.g., performance, industry, risk tolerance, etc.) with a proposed exchange traded product. Stated differently, the object is to create a publicly listed product model (e.g., limited to securities) that will act like the investment path of the past few years (a predetermined time period). Database 500 includes the extract data (e.g., from FIG. 3A or FIG. 3B), including the aggregate and detailed data related to the investment strategies and holdings over the predetermined period of time. For example, this time period may be a period of between 1-10 years. The extract data will be enhanced using analytics/software and additional third party data from database(s) 502. Database(s) 502 includes historical price data, historical income return data, and published return data for the underlying securities included in the extract data. The data is further enhanced using industry and capital classifications at block 504 (e.g., GICs, SICs, large-medium-small cap designations, etc.), and risk characteristics at block 506 (e.g., high risk-high return, moderate risk-moderate return, low risk-low return, etc.). At block 508, analytics/software are used to analyze the historical returns of the enhanced extract data (including the data from database 502, and from blocks 504 and 506) over the predetermined time period to discern driver(s) of the returns, and to select publicly listed securities to construct the ETPs. At block 508, designated risk models and risk weights may be applied to the underlying holdings, while considering factors such as sectors, capitalization markets, overlapping holdings, etc. At block 510, publicly listed securities are reviewed to construct the ETPs. For example, depending on the result of the analytics/software at block 508, certain characteristics may be sought in the publicly listed securities (e.g., desired sectors for investment, percentage of small cap investment versus large cap investment, etc.). At the end of the analysis of block 510 we have a theoretical ETP(s) that desirably tracks desired past performance and/or characteristics of the extract data for a given investor (or group of investors).

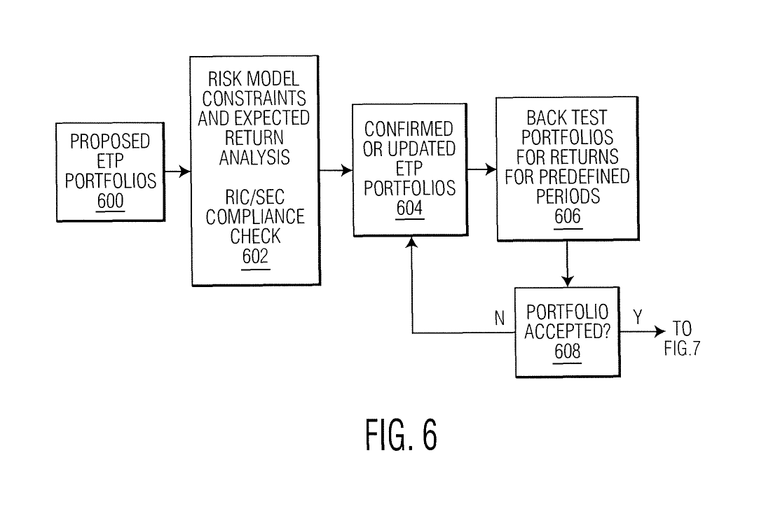

At block 600 of FIG. 6, proposed ETP(s) (and/or groupings of ETPs in an ETP portfolio) are provided (e.g., the output from block 510 of FIG. 5). Because a broader universe of securities, etc. are available for inclusion in the ETP (as opposed to 30 or fewer securities included in an SMA), improved performance with similar risk constraints may be provided as compared to the underying account (e.g., the underlying SMA). For example, a proposed ETP may include a relatively low number of securities (e.g., 20 or more securities) or a larger number (e.g., several hundred securities). In FIG. 6, the objective is to determine if the proposed ETP(s) from block 510 includes the desired characteristics. At block 602, the original risk model constraints and expected returns are analyzed (e.g., using a risk matrix, such as a 3 by 3 matrix of low, medium and high returns by low, medium and high risks, for each investor within the plurality of investors), and a compliance check is done against regulations such as RIC and SEC rules. The output of block 602 may be the proposed ETP (e.g., one or more ETPs from the ETP portfolio) if it is confirmed at block 602, or the ETP(s) may be updated based on the analytics and software at block 602. An ETP portfolio at block 604 may be a portfolio of individual stocks, or a portfolio of ETPs matching the proper risk constraints. The ETPs may be active or passive in construction, but in either case the ETPs desirably produce the same expected returns with the same risk characteristics as the underlying investment. At block 606, the ETP(s) in the ETP portfolio from block 604 are back tested for returns for the predetermined time period. At block 608, if the back tested ETPs are accepted (e.g., they fit within predetermined tolerances/constraints related to one or more investment characteristics such as returns, risk, etc.), then the ETPs in the portfolio (or ones of the ETPs from the portfolio) proceeds to FIG. 7. If the back tested ETPs in the portfolio are not accepted at block 608, then the process returns to block 604 to further update the ETP portfolio. This process may be both automated, and iterative, as several cycles may be needed until the ETPs in the portfolio are accepted at block 608, or a stop is reached in the analytics/software (e.g., a time out feature, etc.).

At FIG. 7, the ETPs go through correlation analytics to show that the proposed ETP groupings behave in a manner similar to the underlying investment (e.g., the underlying SMA or UMA). That is, it is desirable that the ETP constructions are selected such that they meet liquidity standards for the underlying securities, fall within construction rules (e.g., the ETP rules, SEC rules, IRS rules, etc.), and still perform properly for the largest group of investors with specific strategies and risk tolerances. An SMA/UMA investor database 700 is provided. Likewise, another database 702 including all SMA/UMA asset positions is provided (e.g., including brokerage identifier, internal brokerage for the investor, end of day value, and risk tolerance for the investor). At block 704, the proposed ETP investment model is provided including the underlying security investments and risk tolerance. At block 706, analytics/software are used in connection with the content from each of blocks 700, 702, and 704, to assign the investor to one or more ETPs that should return the expected performance of the underlying SMA/UMA model with substantially the same risk tolerances. The assigned ETPs may include a plurality of ETPs (a grouping of ETPs) in a desired ratio to deliver the desired performance and risk tolerance. The output of block 708 is the assigned ETP selection for each investor. The process shown in FIG. 7 may be considered an internal analysis; however, investors may desire to have further assurances that the new ETP(s) behave in a substantially similar manner (e.g., in terms of performance and/or risk) as compared to their underlying investment (e.g., the underlying SMA/UMA). This may be accomplished, for example, using the technique shown in FIG. 8A (for individual investment accounts) or FIG. 8B (for institutional investment accounts).

In FIG. 8A, the ETP grouping (that is considered substantially equivalent to the underlying SMA/UMA in terms of risk and performance) is provided at block 800. The ETP grouping is run back, through block 802 to prove that the ETP grouping performs similar to their underlying SMA/UMA investment. Through this process, the ETP grouping at block 800 is compared to the content of block 802, which represents the underlying investment. That is, block 802 includes linking database 804 (e.g., which stores investor/wirehouse relationships and the SMA/UMA strategy), investor databases 806a-806n, and investor accounts 808a-808n. Using analytics/software, a proof of concept is completed to show that the proposed ETP grouping performs similar to the underlying investment.

FIG. 8B is similar to FIG. 8A, except that it represents the proof of concept related to institutional holdings. The ETP groupings are provided in block 810, and they are compared to the content of block 812, which represents the underlying investment. That is, block 812 includes linking database 814 (e.g., which stores data related to strategies and holdings for institutional clients based on current and future liabilities), investment strategy databases 816a-816n, and custodial holdings 818a-818n (i.e., held by Institutions 1−n). Using analytics/software, a proof of concept is completed to show that the proposed ETP grouping performs similar to the underlying institutional investment.

At FIG. 9, a liquidity analysis is performed with respect to the created ETPs. That is, ETPs have been created to populate the various SMA/UMA accounts at issue (or the institutional holdings). In FIG. 9, these the ETPs are tested for liquidity to confirm that each portfolio (or group of portfolios) can support the asset bases represented by the various investor groupings. This may involve, for example, a trading volume analysis of each security within each ETP portfolio, and a related market impact analysis. In the example described above with respect to FIG. 3A, 10 different investment strategies resulted from the analytics of the thousands of accounts. These 10 investment strategies may have resulted in the creation of 10 ETPs (or 10 combinations of ETPs). Given the volumes of shares at issue for these thousands of accounts, an analysis is performed at FIG. 9 to determine if the products can handle the desired volume. Stated differently, will the investment asset volume set forth for the ETPs fundamentally alter the ETPs—or can the ETPs hold the asset at a desired volume (plus some tolerance)? ETP database 900 is a data structure including data related to the various investment securities of the ETPs, including fundamental data. Block 902 represents data feeds from external data vendors, for example, which provides fundamental data related to the various stocks/securities. At block 904, selection rules for each investment strategy are provided. At block 906, an initial cut of security selection for each investment strategy is provided (e.g., deconstructing each ETP into its underlying securities). The data from block 906, is provided at block 908 (liquidity analysis). Analysis 908 is completed by relation to database 910 (a data structure of historical investors and preferences) and database 912 (a data structure of trading volume and prices). Extract 914 is the output of liquidity analysis 912. This output is an extract of investment strategies securities that meet the liquidity requirement rules (set forth in analysis 908) and the various investor profiles. All or any of these steps may be completed by a single RIA, groups of various RIA, third party service providers, consultants, broker, investment banks or commercial banks. However, the process executed in whole or in part results in SMAs, UMAs, or individual portfolios being grouped together to form one or more ETPs having similar performance objectives, highly correlated performance, and similar risk objectives to the starting portfolios; or where ETPs are deconstructed into individual securities having similar performance objectives, highly correlated performance, and similar risk objectives to the starting ETPs shall be included in this invention.

ETPs (and ETP groupings, ETP portfolios) may also be checked for compliance, for example, with RIC (i.e., registered investment company) and SEC regulations and constraints. FIG. 10 illustrates an example of such a check. Database 1000 of RIC rules is provided, and the ETPs in the ETP portfolio are checked against these rules. At block 1002, the securities of the ETPs that passed the RIC rules are provided. Database 1004 of SEC product structures and constraints is provided, and the securities of block 1002 are checked against these constraints. At block 1006, an extract of possible product types for investor groups is provided, having now passed both the RIC and SEC rules. At block 1008, the ETPs are grouped/sorted into investor product types. Thus, at FIG. 10, the ETPs (and/or ETP groupings) may have changed yet again, because some securities may not have passed the RIC/SEC rules, and as such, ETPs are grouped/sorted into new combinations. Depending on the change (e.g., a change to the regulatory structure), the product may no longer be acceptable, and various steps of the process described herein beginning at FIG. 3A may have to be repeated. Otherwise, we have settled in on the individual ETP components and the grouping of those components. So an ETP portfolio of acceptable products is provided.

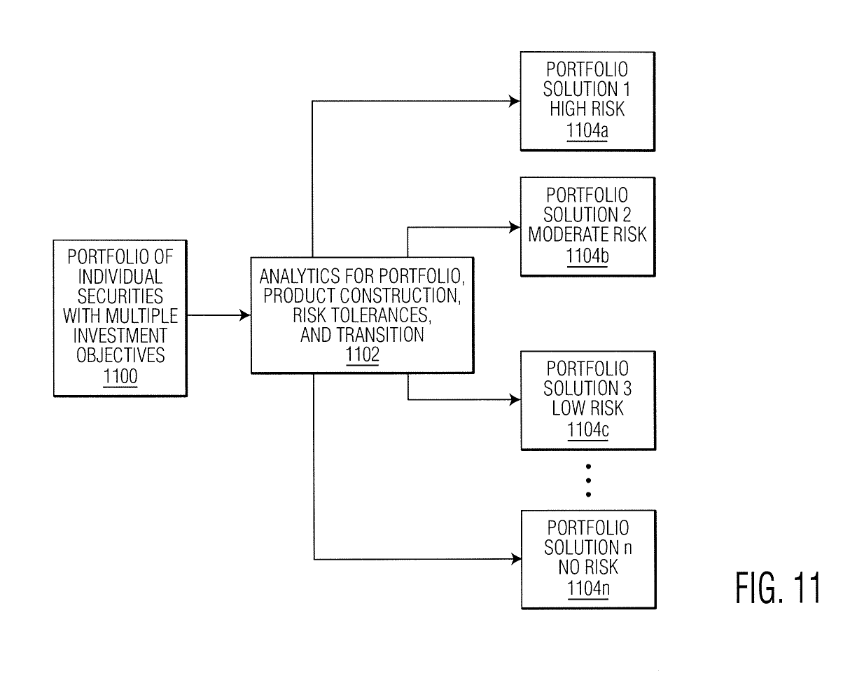

At FIG. 11, an ETP portfolio 1100 of individual securities with multiple investment objectives is provided, and will be packaged into various portfolio solutions. That is, block 1102 includes portfolio analytics, product construction analytics, risk tolerance analytics, ownership cost analytics, and transition portfolio analytics. These different analytics/software are constraints used to support a transition of investor individual holdings into a group of packaged products, for example, having a reduced ownership cost and embedded risk managed solutions in the product design. At blocks, 1104a-1104n, various final portfolio products are provided for various risk groups (e.g., high risk, moderate risk, low risk, no risk). Now we have a combination of ETPs that can be used to replace, for example, an SMA or UMA.

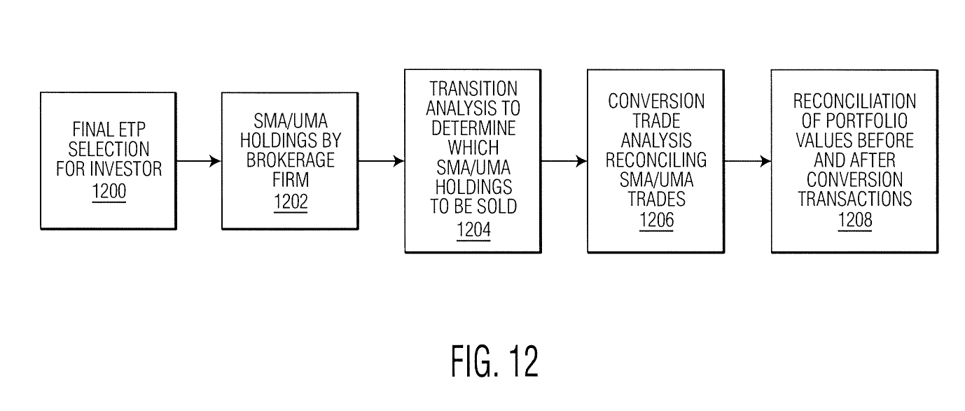

At FIG. 12, the transition/conversion of the underlying SMA/UMA to the new ETP SMA/UMA is illustrated. For example, this may be a final ETP investor allocation to confirm: that the SMA/UMA holdings can be transitioned into the ETP product with a known market impact; and that the transition can be done under acceptable market friction costs so that the holdings from the SMAs/UMAs can be converted through exchange transactions into the listed ETPs with a minimal change in asset holdings over a defined period of time (e.g., which could be as little as one day or as long as multiple trading days) in order to meet the market impact goals that are competitive. Once the conversion for the plurality of investors is completed, the ETPs need to be alloacted into the proper investor accounts and the allocation is reconciled in value to the SMA/UMA account values prior to the conversion process. At block 1200, the final ETP (which may be a combination of a plurality of ETPs) selection for a given investor is provided. At block 1202, the existing investor holdings in the SMA/UMA by a brokerage firm are provided. At block 1204, a transition analysis is completed to determine which SMA/UMA holdings are to be sold, and how the sales of these holdings can be managed to minimize the market impact and to achieve the maximum sales price. At block 1206, a conversion trade analysis is completed where the SMA/UMA transition trades are reconciled to the theoretical portfolios of ETP executions, for example, where the ordinaries held in the SMAs and UMAs are sold, or converted through in-kind transactions into ETP holdings. At block 1208, the portfolio values are reconciled before and after the conversion transactions at the broker and client account basis. Thus, the end result of FIG. 12 is the underlying security (e.g., an SMA) with the holdings (e.g., up to 30 securities) being a combination of ETPs created in accordance with the present invention.

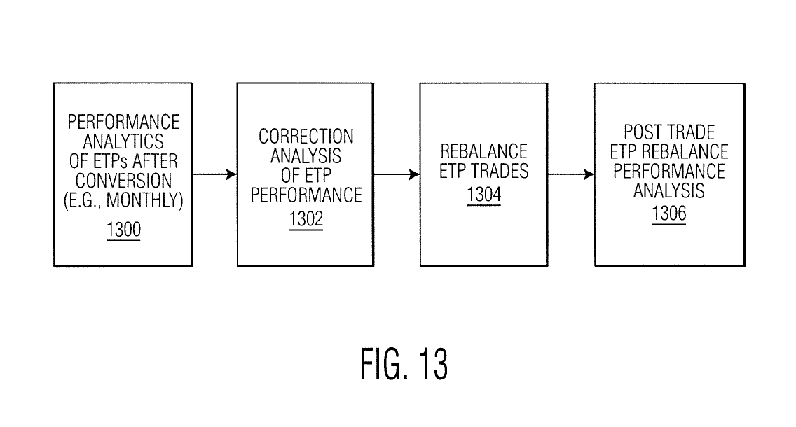

It may be desirable to continuously monitor the performance of the ETPs, for example, on some predetermined interval. Referring now to the example shown in FIG. 13, block 1300 includes performance analytics of the ETPs after conversion. The ETP performance (and/or ETP grouping performance) may be checked following conversion (e.g., on a monthly basis) against the performance of the prior SMA/UMA models that were transitioned. For example, undesirable performance differences (e.g., tracking errors, drift, etc. that are beyond an acceptable tolerance) are noted, and portfolio adjustments (e.g., rebalancing) may be made to compensate for the differences as described in blocks 1302-1306. At block 1302, a correction analysis of the ETP performance is completed, by comparison to the original SMA/UMA models. At block 1304, the ETPs are rebalanced (e.g., through trade) to correct for the performance as determined by the correction analysis. At block 1306, a post trade rebalance performance analysis is completed. Of course, the method illustrated in blocks 1300-1306 may be repeated, as needed, to provide the desired result.

The methods disclosed herein (e.g., methods of constructing exchange traded products, methods of deconstructing exchange traded products, and aspects of each of such methods) may be implemented in a number of alternative mediums. For example, the techniques can be installed on an existing computer system/server as software. Further, the techniques may operate from a computer readable carrier (e.g., solid state memory, optical disc, magnetic disc, radio frequency carrier medium, audio frequency carrier medium, etc.) that includes computer instructions (e.g., computer program instructions) related to, and/or for implementing, the methods.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of creating one or more exchange traded products, the method comprising the steps of:
(a) analyzing a plurality of investor managed individual security accounts to determine at least one investment characteristic for each of a plurality of investors;
(b) generating an investment objective and risk profile for each investor based on the results of step (a); and
(c) creating one or more exchange traded products using the profiles generated for the plurality of investors.

2. The method of claim 1 wherein the exchange traded products include at least one of ETFs, ETCs, ETMFs, and closed end funds.

3. The method of claim 1 wherein the plurality of investor managed individual security accounts include at least one of separately managed accounts (SMAs) and unified managed accounts (UMAs).

4. The method of claim 1 wherein the at least one investment characteristic relates to a risk tolerance for each of the plurality of investors.

5. The method of claim 1 wherein the at least one investment characteristic includes a risk spectrum for each of the plurality of investors.

6. The method of claim 5 wherein the risk spectrum includes an allocation between various risk tolerance levels by allocation percentage for each of the plurality of investors.

7. The method of claim 1, further comprising the step of deconstructing the one or more exchange traded products in order to determine the underlying securities of the one or more exchange traded products.

8. The method of claim 7, further comprising the step of deriving a subset of the underlying securities, the subset of the underlying securities having a substantially similar investment objective and risk profile for a selected investor.

9. The method of claim 7 further comprising the step of acquiring shares of at least a portion of the underlying securities in the each of the plurality of investor managed individual security accounts.

10. The method of claim 1 further comprising the step of selecting a combination of the one or more exchange traded products for each of the plurality of investors.

11. The method of claim 10 further comprising the step of acquiring the selected combination of the one or more exchange traded products for each of the investors.

12. The method of claim 11 wherein the selected combination of the one or more exchange traded products are acquired for each of the investors via an existing investor managed individual security accounts.

13. The method of claim 12 wherein the existing investor managed individual security accounts are separately managed accounts.

14. The method of claim 1 wherein the investment objective and risk profile generated for each investor in step (b) is substantially similar to an investment objective and risk profile determined to correspond to the investor managed individual security account of the respective investor.

15. The method of claim 1 wherein each of the investor managed individual security accounts are institutional holdings accounts.

16. The method of claim 1 further comprising the step of confirming that the one or more exchange traded products created in step (c) may be publicly traded.

17. The method of claim 1 further comprising the step of performing a liquidity analysis with respect to the one or more exchange traded products created in step (c).

18. A computer readable carrier including computer program instructions which cause a computer to implement a method of creating one or more exchange traded products, the method comprising the steps of:
(a) analyzing a plurality of investor managed individual security accounts to determine at least one investment characteristic for each of a plurality of investors;
(b) generating an investment objective and risk profile for each investor based on the results of step (a); and
(c) creating one or more exchange traded products using the profiles generated for the plurality of investors.

19. A system for creating one or more exchange traded products, the system comprising:
at least one computer including computer program instructions for creating the one or more exchange traded products;
at least one assembled data structure, assembled by the at least one computer, for use in creating the one or more exchange traded products; and
at least one third party data structure used in connection with the at least one assembled data structure and the computer program instructions for creating the one or more exchange traded products.

20. The system of claim 19 wherein the at least one computer includes further computer program instructions for deconstructing the one or more exchange traded products into at least a portion of a group of securities underlying the one or more exchange traded products.
